(19) United States
(12) Patent Application Publication
(10) Pub. No.: US 2016/0366013 A1
(43) Pub. Date: Dec. 15, 2016

(54) NETWORK SYSTEM

(71) Applicant: HITACHI, LTD., Tokyo (JP)

(72) Inventors: Ken AKUNE, Tokyo (JP); Hitoshi YABUSAKI, Tokyo (JP); Kazuhiro MAEDA, Tokyo (JP); Junji KINOSHITA, Tokyo (JP)

(73) Assignee: HITACHI, LTD., Tokyo (JP)

(21) Appl. No.: 15/080,699

(22) Filed: Mar. 25, 2016

(30) Foreign Application Priority Data
Jun. 11, 2015 (JP) 2015-117930

(51) Int. Cl. H04L 12/24; H04L 12/66; H04L 12/46; H04L 12/26

(52) U.S. Cl. CPC H04L 41/0803; H04L 41/12; H04L 43/08; H04L 12/66; H04L 12/4641

(57) ABSTRACT

Provided is a network system including a management device and one or more external networks which connect each of any two of computer systems, wherein the management device acquires communication performance of each of the external networks among a bandwidth, a delay, and a maximum transferable packet, receives a calculation request for the communication performance of a virtual network, specifies a configuration of the requested virtual network, calculates the communication packet of the specified virtual network based on the acquired communication performance of the external network, and provides information of the calculated communication performance of the virtual network to a manager.

### CLAIM OF PRIORITY

The present application claims priority from Japanese application JP 2015-117930 filed on Jun. 11, 2015, the content of which is hereby incorporated by reference into this application.

### BACKGROUND OF THE INVENTION

Field of the Invention

The disclosed subject matter relates to a network system transmitting communication packets by using a virtual network.

Description of the Related Art

In recent years, with the advance of server virtualization, companies, organizations and the like have used DCs (data centers) in application such as a cloud. Under these circumstances, a business system is configured as a server cluster spreading a plurality of DC or a plurality of zones. As a result, at the time of DC failure or server failure, VM (virtual machine) in which a business system run can be automatically moved to a different DC or a different zone, so that influence of the failure on the business system can be reduced.

In addition, a virtual NW (network) is constructed without limitation in a physical NW configuration, so that, even in a case where the VM is moved to the different DC or the different zone on the server cluster, change in the configuration of the physical NW is unnecessary. In the virtual NW, for example, in a TCP (Transmission Control Protocol)/IP (Internet Protocol) NW, for example, a gateway or the like having a tunneling technology such as a VXLAN (Virtual eXtensible Local Area Network) or an IPsecVPN (IP security Virtual Private Network) is used.

However, in inter-VM communication on the virtual NW, communication performance of the physical NW is not taken into consideration, in some cases, the inter-VM communication is influenced by physical communication performance according to a location where the VM is stored.

Hereinafter, cited technologies relating to the above-described problem will be described.

Patent Document 1 (Japanese Patent Application Publication 2014-230057) discloses that first and second physical machines are connected to each other via a plurality of physical networks, and when a first VM operating on the first physical machine transmits a frame to a second VM operating on the second physical machine, a physical network supporting specified QoS is used (in an abstract).

If the above-described method of Patent Document 1 is used, in a case where the virtual NW using the plurality of physical NWs is configured between computer systems constituting the network system, maximum communication performance of the virtual NW depends on the physical NW having the lowest communication performance between the computer systems. Low communication performance denotes one or more of a narrow bandwidth in the case of a bandwidth, a long delay in the case of a delay, a small transferable packet length in the case of a maximum transferable packet length, and a large number of transferred communication packets in the case of the number of transferred communication packets.

For this reason, the bandwidth or the like of the physical NW may not be effectively used. For example, in a case where the plurality of physical NWs constituting the virtual NW includes a physical NW having a wide bandwidth and a physical NW having a narrow bandwidth, a maximum bandwidth of the virtual NW depends on the physical NW having a narrow bandwidth.

### SUMMARY OF THE INVENTION

The disclosure is a network system calculating communication performance of a virtual NW by taking into consideration communication performance of a physical NW.

In addition, the disclosure is also a NW management device, a gateway, and a network providing method capable of improving inter-VM communication performance by reconfiguring the network system for each tenant based on the calculated communication performance.

The present invention discloses a network system including a plurality of computer systems and a plurality of physical NWs, wherein a NW management device calculates communication performance of a virtual NW based on communication performance of the physical NW.

In a specific aspect, the NW management device measures one or more values of a bandwidth, a delay, and a maximum transferable packet length of the physical NW and calculates the communication performance of the bandwidth, the maximum transferable packet length or the like for each virtual NM by associating the communication performance of the physical NW with the configuration of the physical NW and the configuration of the virtual NW.

In addition, in a case where the plurality of physical NWs constituting the virtual NW includes the physical NW having low communication performance, the NW management device remove the physical NW from the physical NW which becomes a configuration source of the virtual NW and re-designs the virtual NW, so that the communication performance can be improved.

In addition, in a case where the communication performance provided as information to the NW management device does not satisfy performance requirements, the tenant manager may instruct re-setting, that is, changing of the performance requirements according to the communication performance.

More specifically, the NW management device may provide, for example, the communicatable maximum transferable packet length of the VM as the communication performance to the tenant manager. Due to the providing, the tenant manager can re-set the maximum transferable packet length of the VM among the performance requirements.

According to the above-described configuration, it is also possible to solve a problem in that the communication packet between the VMs is encapsulated by a tunneling technology such as a VXLAN and the VM cannot perceive the maximum transferable packet length after the encapsulation.

Herein, although the example where the NW management device performs notification is illustrated, any one or more device of the NW management device and the gateway may perform notification and setting of the maximum transferable packet length.

In addition, the NW management device determines based on the calculation result whether or not the performance requirements of the tenant manager are satisfied, and in a case where the performance requirements are not satisfied, a function of proposing reconfiguration of the server cluster or movement destination of the VM may also be equipped.

The tenant manager may determine the reconfiguration of the server cluster or the movement of the VM by taking into consideration the notification content so that the influence of deterioration in the communication performance by the physical NW having the low communication performance is suppressed and the communication performance of the virtual NW is improved and may indicate the determination result to a VM management device.

When the VM management device receives a request from the tenant manager, the VM management device performs reconfiguration of the server cluster or the movement of the VM, it is possible to suppress the influence of the deterioration in the performance by the physical NW having the low performance, and it is possible to improve the communication performance of the virtual NW. Without using the VM management device, the tenant manager may directly manipulate the movement of the VM.

Furthermore, the NW management device may include both of the second and third aspects.

According to the disclosure, it is possible to implement a network system capable of improving communication performance of the system using a virtual NW.

In the specification, at least one embodiment of the disclosed subject matter will be described in detail with reference to the attached drawings and the description hereinafter. Other features, aspects, effect of the disclosed subject matter will be clarified by the disclosure, the drawings, and the claims hereinafter.

### BRIEF DESCRIPTION OF THE DRAWINGS

FIG. 1 illustrates a system configuration example of a network system according to an embodiment.

FIG. 2 illustrates an embodiment where VMs are moved in a case where performance requirements of a tenant manager are not satisfied in FIG. 1.

FIG. 3 illustrates a block configuration example of an NW management device illustrated in FIG. 1.

FIG. 4 illustrates a block configuration example of a gateway illustrated in FIG. 1.

FIG. 5 illustrates a configuration example of a gateway information management table.

FIG. 6 illustrates a configuration example of an external NW information management table.

FIG. 7 illustrates a configuration example of a virtual NW information management table.

FIG. 8 illustrates a configuration example of a virtual NW-external NW associated management table.

FIG. 9 illustrates a configuration example of a virtual NW-internal NW associated management table.

FIG. 10 illustrates a configuration example of an internal NW-VM associated management table.

FIG. 11 illustrates a configuration example of a host-VM associated management table.

FIG. 12A illustrates an operation sequence of the network system according to the embodiment.

FIG. 12B illustrates an operation sequence of the network system according to the embodiment.

FIG. 13 illustrates a flow of a communication performance calculating process for a virtual NW by the NW management device illustrated in FIG. 12A.

FIG. 14 illustrates a flow of a substitution proposal producing process for the virtual NW by the NW management device illustrated in FIG. 12B.

FIG. 15 illustrates a flow of another process associated with production of a substitution proposal for the virtual NW by the NW management device illustrated in FIG. 14.

### DETAILED DESCRIPTION OF THE PREFERRED EMBODIMENTS

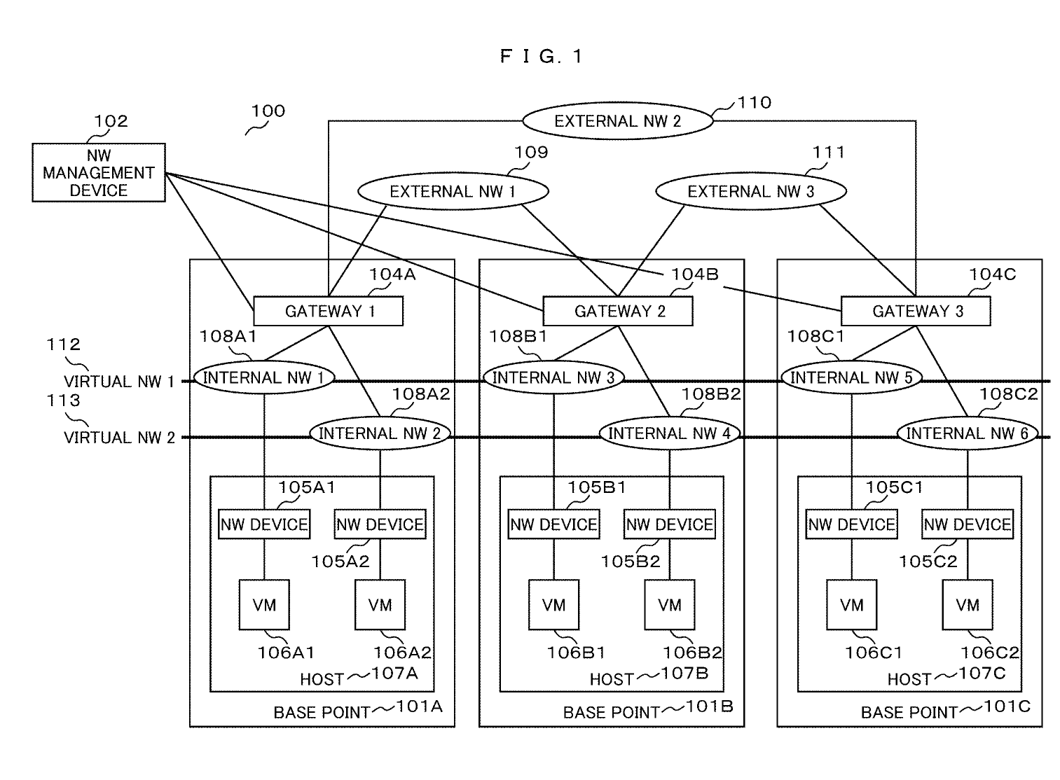

FIG. 1 is an explanation diagram illustrating a system configuration example according to an embodiment of a network system which is assumed to be applied to business system or the like. In a network system 100, computer systems (hereinafter, referred to as base points) 101A, 101B, and 101C which exist in a plurality of (three as an example in FIG. 1) base points are communicatably connected to each other through gateways 104A, 104B, and 104C and are connected to a NW management device 102.

In the description hereinafter, the end of a reference sign indicating a device in the base point 101A is affixed with the ending character “A” of the reference sign indicating the base point 101A, the end of a reference sign indicating a device in the base point 101B is affixed with the ending character “B” of the reference sign indicating the base point 101B, and the end of a reference sign indicating a device in the base point 101C is affixed with the ending character “C” of the reference sign indicating the base point 101C. In a case where a plurality of the same type devices exist, the ending character is affixed with ending numbers such as “A1” and “A2” for further distinguishment. For example, the NW device 105A1 is a NW device in the base point 101A.

In a case where base points are not to be distinguished, ending characters and ending numbers of reference signs indicating devices are omitted. For example, the base point 101 is a generic term for the base points 101A, 101B, and 101C, and the NW device 105 is a generic term for the NW devices 105A1, 105A2, 105B1, 105B2, 105C1, and 105C2. In addition, in a case where the same type devices in a base point are not to be distinguished, ending numbers are omitted. For example, the NW device 105A is a generic term of the NW devices 105A1 and 105A2.

The base point 101 is any one of configurations called, for example, data center, zone, or island. The island exists in every tenant and is a computer group for a tenant. The zone is a set of islands. The data center is a set of zones. In each base point 101, a gateway 104, an NW device 105, a VM 106, a host 107, and an internal NW 108 are connected.

The NW management device 102 manages information of the gateway 104, information of external NWs 109 to 111, information of the internal NW 108, information of virtual NWs 112 and 113 and controls the gateway 104 based on the information. In an environment where the NW management device can communicate with the gateway 104, the NW management device 102 may be disposed in any one of the base points 101. In addition, the number of NW management devices 102 is not limited to one, but a plurality of NW management devices may be used.

The implementation form of the NW management device 102 may be a physical machine or a virtual machine.

The gateway 104 has a tunneling function, for example, VXLAN (Virtual eXtensible Local Area Network) or the like in addition to a layer-2 switching function and a layer-3 switching function of performing a communication packet transferring process. The implementation form of the gateway 104 may be a physical machine or a virtual machine.

The NW device 105 is a layer-2 switch which mainly performs a communication packet transferring process. The implementation form of the NW device 105 may be a physical machine or a virtual machine.

The VM 106 is a computer which communicates with other VMs 106 in its own or other base points 101. In the embodiment, although the VM 106 is described as a virtual computer, the implementation form of the VM 106 may be a physical machine.

The host 107 is a computer (in the specification, referred to as a server) which stores zero or more VMs 106. In the embodiment, although the host 107 is described as a physical computer, the implementation form of the host 107 may be a virtual machine.

The internal NW 108 is an NW which connects devices in the base point 101 and is, for example, a LAN (Local Area Network). In the embodiment, the internal NW is described as an NW which non-encapsulated communication packets pass through. A plurality of internal NWs 108 may exist in one base point 101.

The external NW 109 is a physical NW which connects the base point 101A and the base point 101B, the external NW 110 is a physical NW which connects the base point 101A and the base point 101C, and the external NW 111 is a physical NW which connects the base point 101B and the base point 101C.

In the embodiment, the external NWs 109 to 111 are physical NWs which encapsulated communication packets pass through.

As the external NWs 109 to 111, for example, the internet, a private line, a Wide Area Ethernet (Ethernet is a registered trademark) is used.

The virtual NWs 112 and 113 virtually connect the internal NWs 108 of the base points 101. The virtual NW is configured to include two or more internal NWs and one or more external NWs. The virtual NW can be configured without being constrained to the physical NW configuration. As an implementation method for the virtual NW, for example, there is a tunneling technology using VXLAN, IPsecVPN (IP secure Virtual Private Network), or the like.

In the example of FIG. 1, the internal NW 108A1, the internal NW 108B1, the internal NW 108C1, and the external NWs 109 to 111 constitute a virtual NW 112, and the internal NW 108A2, the internal NW 108B2, the internal NW 108C2, and the external NWs 109 to 111 constitute a virtual NW 113.

In the embodiment, by calculating the communication performance of the virtual NW from the communication performance of the physical NW and changing the physical configuration of the network system based on a calculation result, the communication performance can be improved. Even in a case where the network system according to the embodiment is applied to a business system or the like, the performance can be improved.

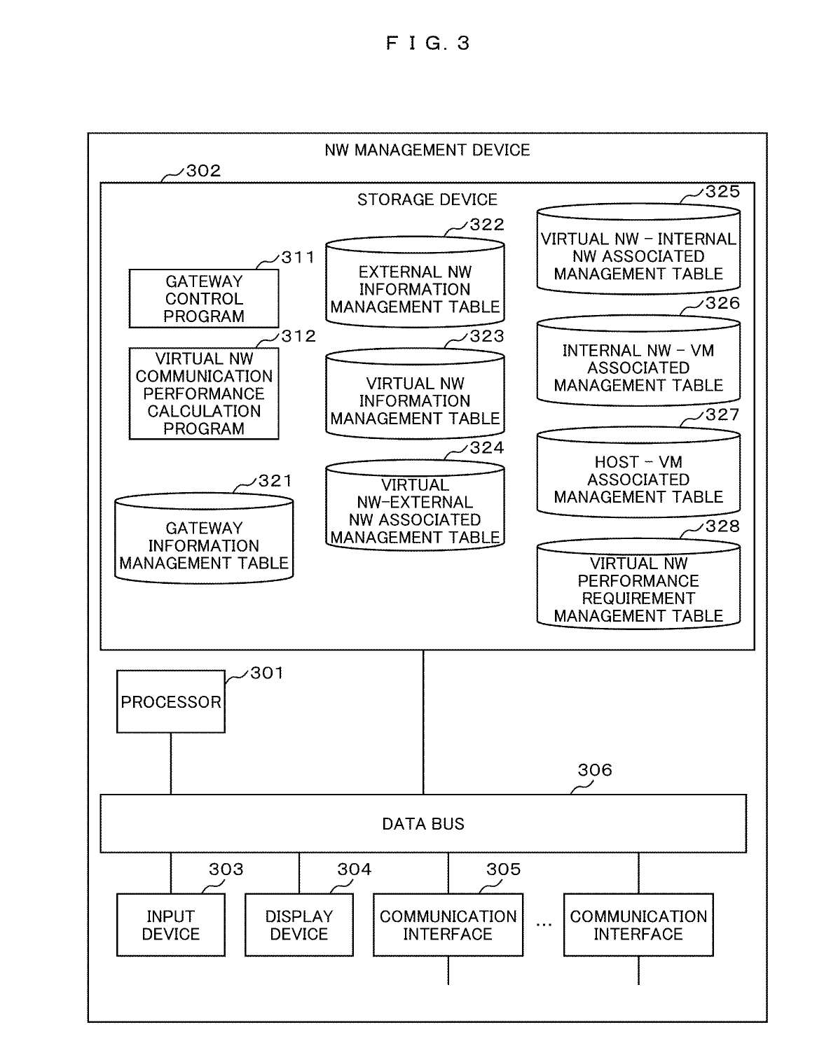

FIG. 3 is a block diagram illustrating an example of a hardware configuration of the NW management device 102. The NW management device 102 is implemented on a computer including a processor 301, a storage device 302, an input device 303, a display device 304, and a communication interface 305 which are connected via a data bus 306.

The processor 301 controls the NW management device 102. The storage device 302 is a non-temporary or temporary recording medium which stores programs 311 and 312, data, and tables 321 to 328 and is also a work area of the processor 301. All the programs 311 and 312 may be stored in the storage device 302 in advance or may be introduced from an external device as needed. As the storage device 302, there is, for example, a ROM (Read Only Memory), a RAM (Random Access Memory), an HDD (Hard Disk Drive), or a flash memory.

The input device 303 is used for data input, and there is, for example, a keyboard, a mouse, a touch panel, a numeric keypad, or a scanner. The display device 304 displays data and is, for example, a display. The communication interface 305 connects the internal NW and the external NW to transmit and receive the data.

The processor 301 implements various processes described hereinafter by executing various programs 311 and 312 and using the storage device 302 and the communication interface 305. In the description hereinafter, programs 311 and 312 are described as execution subjects.

A portion or all of functions implemented by the programs 311 and 312 may be implemented in a dedicated hardware manner.

A gateway control program 311 instructs the corresponding gateway 104 to measure any one or more of communication performances of bandwidth, delay, maximum transferable packet length, and the number of transferred communication packets with reference to a gateway information management table 321 and an external NW information management table 322. A communication performance measurement method is implemented as a known method such as PING or a unique method.

The NW management device 102 corrects measurement results from the gateway 104 and stores the measurement results in the external NW information management table 322.

A virtual NW communication performance calculation program 312 acquires one or more external NW IDs associated with the virtual NW ID from the virtual NW-external NW associated management table. The virtual NW ID is identification information by which the NW management device 102 uniquely specifies a virtual NW, and the external NW ID 601 is identification information by which the NW management device uniquely specifies an external NW. The virtual NW communication performance calculation program 312 acquires communication performance associated with the corresponding external NW ID from the external NW information management table and associates the virtual NW ID and the communication performances of one or more external NWs. After associating the virtual NW with the external NW, the program calculates the communication performance of each virtual NW from the communication performances of one or more external NW.

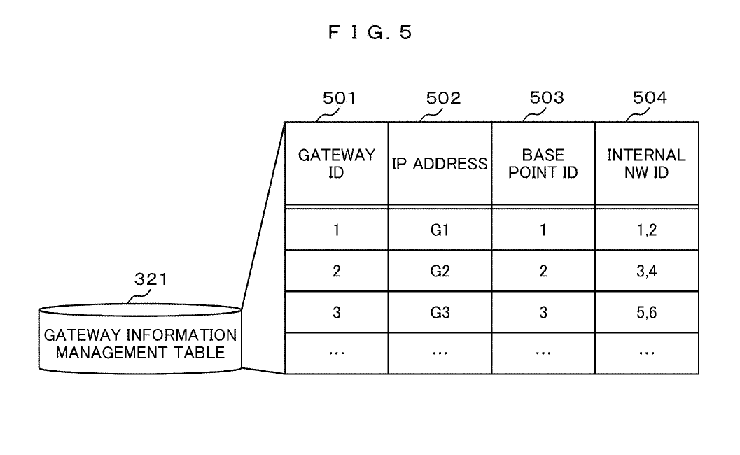

The gateway information management table 321 will be described later with reference to FIG. 5.

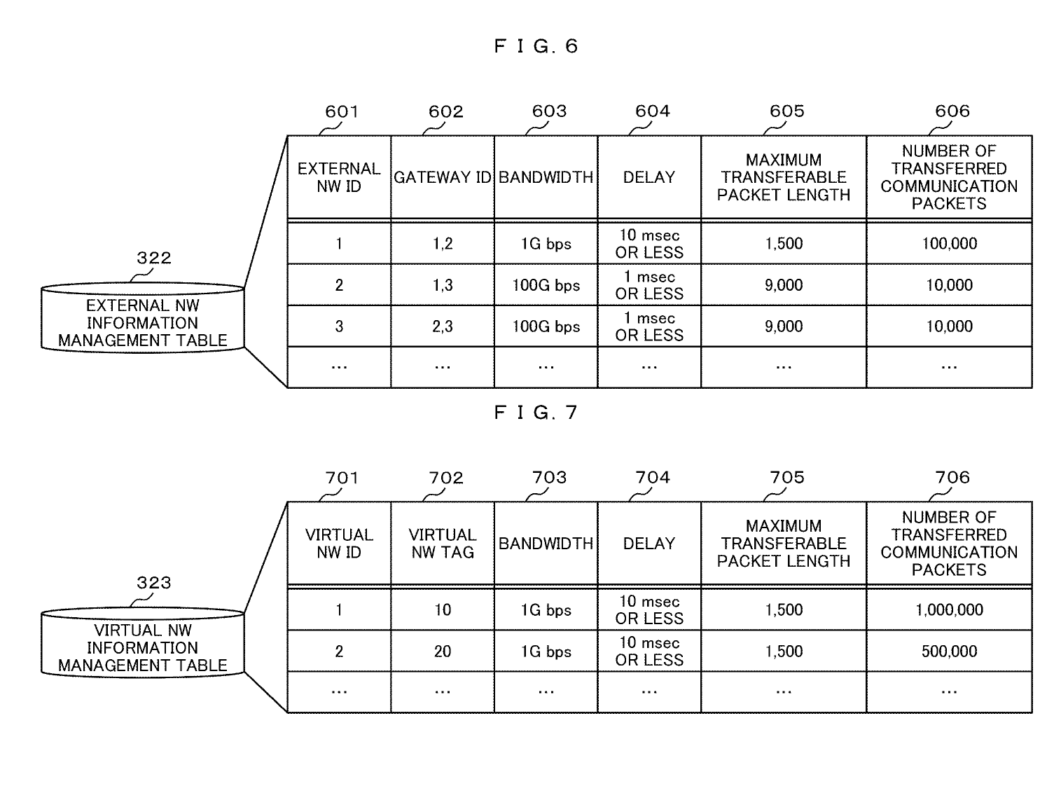

The external NW information management table 322 will be described later with reference to FIG. 6. The external NW information management table 322 is information on the belonging gateways and information for managing one or more communication performances with respect to each external NW. Herein, the communication performance is any one of, for example, a bandwidth, a delay, a maximum transferable packet length, and the number of transferred communication packets of an external NW.

The gateway control program 311 measures any one or more of bandwidth, delay, and maximum transferable packet by instructing to the target gateway, and stores the measurement result in the external NW information management table 322. The measurement may be performed by instructing the gateway to execute a well-known method such as PING or IPPERF or may be performed by using a unique method.

The virtual NW information management table 323 is information for managing one or more of tag (identifier affixed at the time of construction of the virtual NW, hereinafter, the identifier is referred to as a tag), a bandwidth, a delay, and a maximum transferable packet of the belonging virtual NW with respect to the virtual NW. The virtual NW tag is a virtual NW identifier which the gateway 104 affixes at the time of production of the virtual NW and is, for example, a VNI (VXLAN Network Identifier).

The virtual NW communication performance calculation program 312 calculates any one or more of bandwidth, delay, maximum transferable packet of the virtual NW by using the external NW information management table 322, the virtual NW-external NW associated management table 324, and the virtual NW-internal NW associated management table 325 and stores the calculation result in the virtual NW information management table 323.

The virtual NW-external NW associated management table 324 is information of association of the virtual NW and the external NW. The virtual NW-internal NW associated management table 325 is information of association of the virtual NW and the internal NW. The NW management device 102 specifies the internal NW 108 and the external NWs 109 to 111 constituting the virtual NW by using the tables 324 and 325.

The internal NW-VM associated management table 326 is information of association of the internal NW and the VM. The host-VM associated management table 327 is information of association of the host and the VM. The virtual NW communication performance requirement management table 328 is information of association of the virtual NW and the performance requirements of the tenant manager.

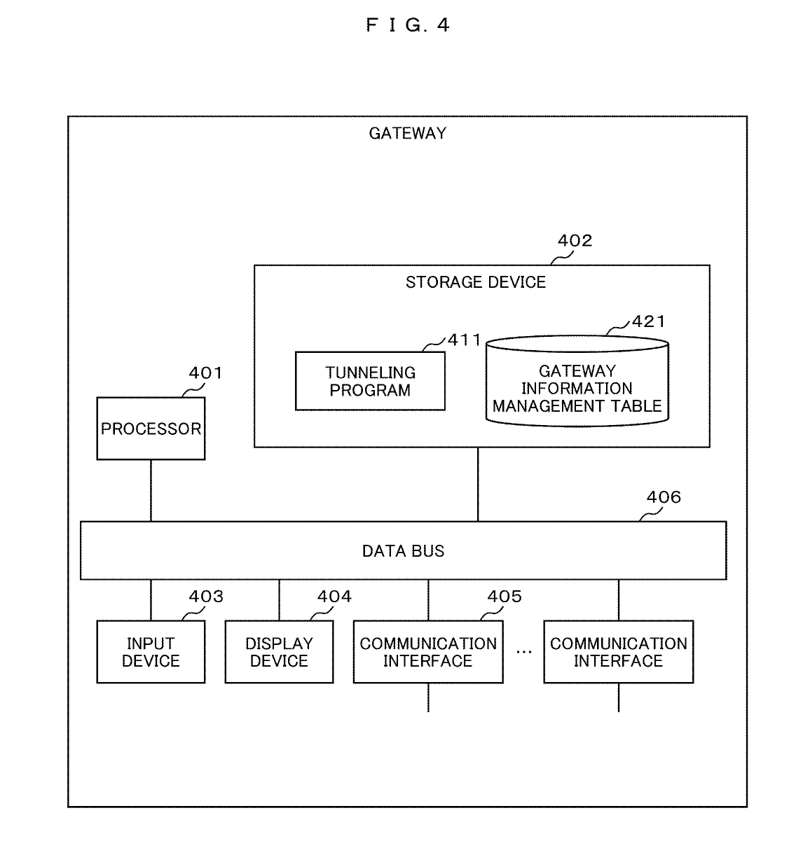

FIG. 4 is a block diagram illustrating an example of a hardware configuration of the gateway 104. The gateway 104 is implemented on a computer including a processor 401, a storage device 402, an input device 403, a display device 404, and a communication interface 405 which are connected via a data bus 406.

The storage device 402 is a non-temporary or temporary storage medium which stores a program 411, data, and a table 421 and is also a work area of the processor 401. The program 411 may be stored in the storage device 402 in advance or may be introduced from an external device as needed. As the storage device 402, there is, for example, a ROM (Read Only Memory), a RAM (Random Access Memory), an HDD (Hard Disk Drive), or a flash memory.

The input device 403 is used for data input, and there is, for example, a keyboard, a mouse, a touch panel, a numeric keypad, or a scanner. The display device 404 displays data and is, for example, a display. The communication interface 405 connects one or more internal NWs and one or more external NWs to transmit and receive the data.

The processor 401 implements various processes described hereinafter by executing the program 411 and using the storage device 402 and the communication interface 405. In the description hereinafter, the program 411 is described as an execution subject.

A portion or all of functions implemented by the program 411 may be implemented in a dedicated hardware manner.

The tunneling program 411 performs encapsulation of the communication packet received from the internal NW in its own base point and decapsulation of the encapsulated communication packet received from the external NW. A tunneling protocol used for the encapsulation may be an arbitrary protocol such as VXLAN or IPsecVPN.

FIG. 5 illustrates a configuration example of the gateway information management table 321. The gateway information management table 321 is information for managing the base points 101 of control objects and network address information of the gateways in an association manner and is produced according to operation or instruction of the tenant manager at the time of construction of the network system.

The gateway information management table 321 includes a gateway ID 501, an IP address 502, a base point ID 503, and an internal NW ID 504 in an association manner.

The gateway ID 501 stores an ID for identifying the gateway 104 as a value. The IP address 502 stores an IP address as a value by which the NW management device 102 controls the gateway 104. The base point ID 503 stores an ID for specifying a storage site of the gateway. The internal NW ID 504 stores an ID for specifying the internal NW which the gateway is connected to.

FIG. 6 illustrates a configuration example of the external NW information management table 322. The external NW information management table 322 includes an external NW ID 601, a gateway ID 602, a bandwidth 603, a delay 604, and a maximum transferable packet length 605. The maximum transferable packet length 605 is a maximum communication packet length which can be transferred on a communication path and is, for example, a MTU (Maximum Transmission Unit) value or the like. In a case where the size of a communication packet from the gateway 104 or the VM 106 exceeds the maximum transferable packet length, in the middle of the communication path, the communication packet is discarded, or the size of the communication packet is divided and reconfigured into communicatable sizes of the communication packet.

With respect to the external NW information management table 322, at the time of construction of the network system, the external NW ID column 601 and the gateway ID column 602 are produced according to manipulation or instruction of the tenant manager, and values of the bandwidth column 603, the delay column 604, the maximum transferable packet length column 605, and the number of transferred communication packets 606 of the external NW are produced by the NW management device 102.

The external NW ID 601 stores identification information for uniquely specifying the external NW as a value. The gateway ID 602 stores a gateway ID group which is connected to the external NW ID 601 as a value. The gateway 104 connected to the external NWs 109 to 111 can be specified by the external NW ID 601 and the gateway ID 602. The bandwidth 603, the delay 604, the maximum transferable packet length 605, and the number of transferred communication packets 606 store values, for example, information of bandwidth, delay, maximum transferable packet length, the number of transferred communication packets 606 of the external NW, which are measured by the NW management device 102 through the gateway 104.

FIG. 7 is an explanation diagram illustrating a configuration example of the virtual NW information management table 323 included in the NW management device 102. The virtual NW information management table 323 has a virtual NW ID 701, a virtual NW tag 702, a bandwidth 703, a delay 704, a maximum transferable packet length 705, and the number of transferred communication packets 706 as management items.

With respect to the virtual NW information management table 323, at the time of production of the virtual NW, the virtual NW ID column 701 and the virtual NW tag column 702 are produced according to manipulation or instruction of the tenant manager, and the bandwidth column 703, the delay column 704, the maximum transferable packet length column 705, and the number of transferred communication packets 706 of the virtual NW are produced by the NW management device 102.

The virtual NW ID 701 stores identification information by which the NW management device 102 uniquely specifies the virtual NW as a value. The virtual NW tag 702 is a virtual NW identifier which is affixed by the gateway 104 at the time of production of the virtual NW and is, for example, a VNI (VXLAN Network Identifier). The bandwidth 703, the delay 704, and the maximum transferable packet length 705 store information of bandwidth, delay, and maximum transferable packet length of the virtual NW which the NW management device 102 calculates from the external NW information management table 322, the virtual NW-external NW associated management table 324, and the virtual NW-internal NW associated management table 325. The number of transferred communication packets 706 stores the number of transferred communication packets for each virtual NW tag measured by the NW management device 102 through the gateway.

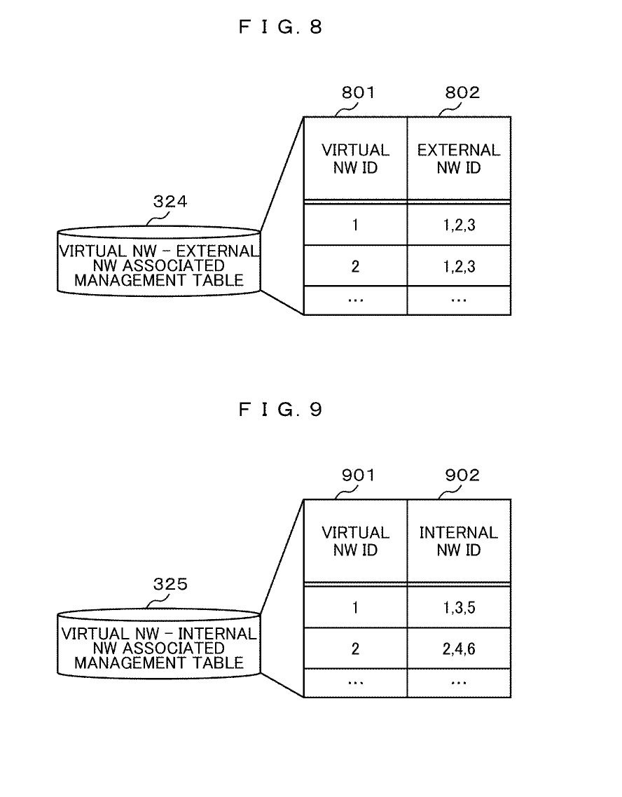

FIG. 8 illustrates a configuration example of the virtual NW-external NW associated management table 324. The virtual NW-external NW associated management table 324 includes a virtual NW ID 801 and an external NW ID 802 in an association manner.

FIG. 9 illustrates a configuration example of the virtual NW-internal NW associated management table 325. The virtual NW-internal NW associated management table 325 includes a virtual NW ID 901 and an internal NW ID 902 in an association manner.

At the time of construction of the network system or at the time of production of the virtual NW, the table is produced according to operation or instruction of the tenant manager, and the table is stored in the NW management device 102.

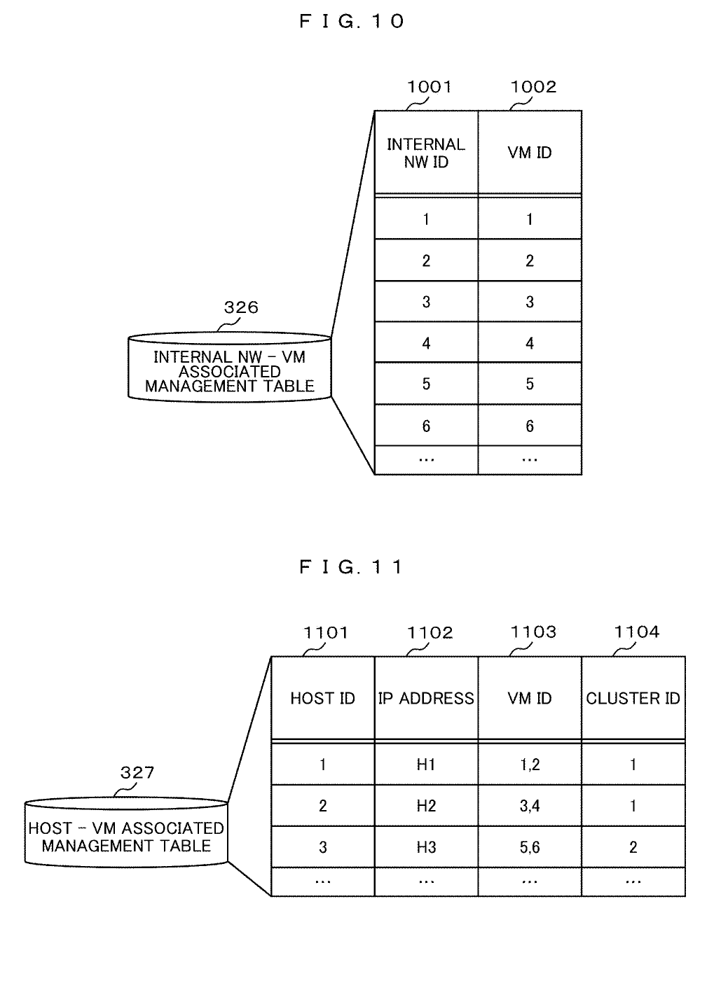

FIG. 10 illustrates a configuration example of the internal NW-VM associated management table 326. The internal NW-VM associated management table 326 includes an internal NW ID 1001 and a VM ID 1002 in an association manner. The VM ID 1002 is identification information for uniquely specifying the VM.

FIG. 11 is an explanation diagram illustrating a configuration example of the host-VM associated management table 327. The host-VM associated management table 327 includes a host ID 1101, an IP address 1102 of a host, a VM ID 1103, and a cluster ID 1104 in an association manner.

The host ID 1101 is identification information for uniquely specifying the host. The IP address 1102 of the host is an IP address by which the NW management device is connected to the host 107. The cluster ID 1104 is information for uniquely identifying a cluster configured with one or more hosts. The VM can move within the same cluster. More specifically, for example, a VM ID 1 can moves from a host ID 1 to a host ID 2 within the same cluster.

The tables 326 and 327 are included in the NW management device 102.

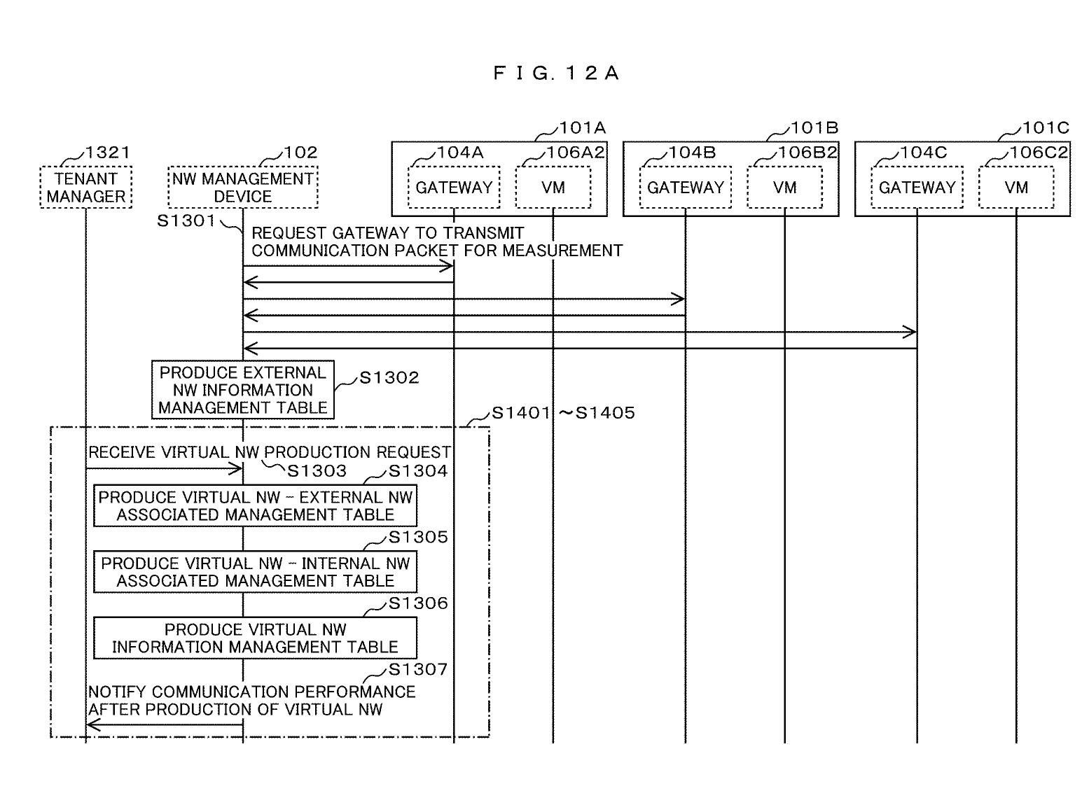

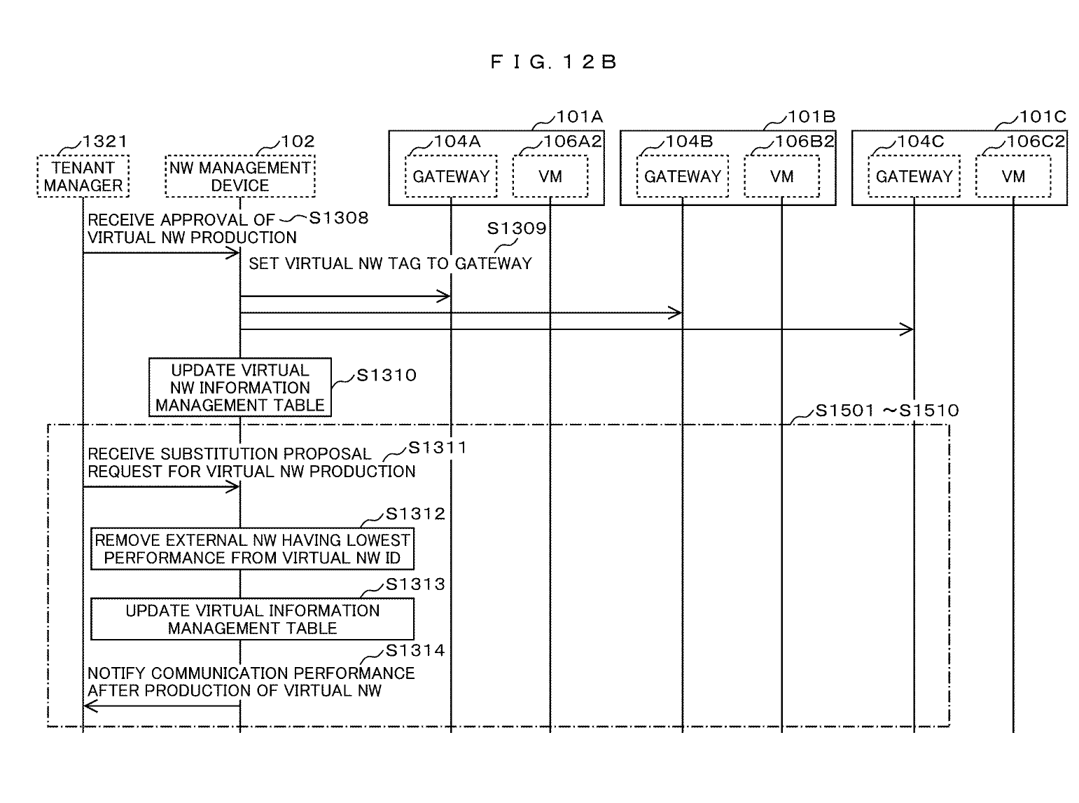

FIG. 12 is a sequence example in a construction period for the virtual NW in the network system 100.

In the sequence, a request message from the tenant manager 1321 to the NW management device 102 is transmitted by, for example, the tenant manager 1321 manipulating a manager terminal (not shown) and using a CLI (Command Line Interface) or a GUI (Graphical User Interface). At the time of transmission, the protocol may be a well-known method such as SSH (Secure Shell) or HTTP (HyperText Transfer Protocol) or may be a unique method. A reply message from the NW management device 102 to the tenant manager 1321 is transmitted through a GUI or the like.

A request message from the NW management device 102 to the gateway 104 is transmitted through, for example, a CLI or a GUI. At the time of transmission, the protocol may be a well-known method such as SSH (Secure Shell) or HTTP (HyperteXt Transfer Protocol) or may be a unique method. In addition, the format of the reply message from the gateway 104 to the NW management device 102 may be a well-known method such as JSON (JavaScript Object Notation, JavaScript is a registered trademark) or may be a unique method.

At the time of construction of the network system, the gateway control program 311 of the NW management device 102 specifies the to-be-controlled gateway 104 from the external NW information management table 322 and requests the gateway 104 to transmit the communication packet in order to measure the communication performance (step S1301).

More specifically, the NW management device 102 acquires the gateway ID 1 and the gateway ID 2 from the gateway ID column 602 of the external NW information management table 322, acquires the IP address G1 and the IP address G2 corresponding to the gateway ID 1 and the gateway ID 2 from the gateway information management table 321, and specifies the IP address of the to-be-controlled gateway. The gateway control method may be a well-known method such as TELENT or SSH or may be a unique method, and the measurement method may be a well-known method such as PING or may be a unique method.

If the gateway control program 311 of the NW management device 102 acquires the measurement result from the gateway, the measurement result is input to the performance items (for example, the bandwidth column 603, the delay column 604, and the maximum transferable packet length column 605) of the external NW in the external NW information management table 322 (step S1302). The NW management device 102 may be configured to repetitively execute steps S1301 and S1302 in response to the request of the tenant manager 1321.

If the external NW information management table 322 is available, when the NW management device 102 receives a virtual NW production request from the tenant manager 1321 (step S1303), the NW management device 102 produces the virtual NW-external NW associated management table 324 and the virtual NW-internal NW associated management table 325 with respect to the received request (steps S1304 and S1305).

More specifically, for example, if the NW management device 102 receives a registration request of the virtual NW having an ID of 2 which uses the internal NWs of which internal NW IDs are 2, 4, and 6 from the tenant manager 1321, the NW management device inputs the request content in the items of the virtual NW ID 2 of the virtual NW-internal NW associated management table 325, specifies the actually-passing external NW from the gateway information management table 321 and the external NW information management table 322, and input the requested virtual NW ID (for example, 2) in the virtual NW ID column of the virtual NW-external NW associated management table 324 and the specified external NW IDs (for example, 1 to 3) in the external NW ID column.

Furthermore, the number of tenant managers 1321 may be one or more, and the NW management device 102 may receive requests from two or more tenant managers 1321. In addition, the NW management device 102 may receive one or more requests from one tenant manager 1321.

The NW management device 102 repeats the above-described process by the number of received requests.

The NW management device 102 produces the virtual NW information management table 323 based on information of the table 322 and the tables 324 and 325 (step S1306). More specifically, for example, the NW management device acquires external NW IDs 1 to 3 associated with the virtual NW ID 2 from the virtual NW-external NW associated management table 324 and acquires performances (for example, a bandwidth, a delay, and a maximum transferable packet length) of the external NW IDs 1 to 3 from the external NW information management table 322. More specifically, the bandwidth and the maximum transferable packet length are calculated as minimum values, and the delay is calculated as a maximum value. The NW management device inputs the calculation result in the items (for example, a bandwidth column, a delay column, and a maximum transferable packet length column) of the virtual NW ID 2 of the virtual NW information management table 323.

The NW management device 102 notifies the calculated communication performances (for example, values of bandwidth, delay, and maximum transferable packet length) of the virtual NW to the tenant manager 1321 with reference to the virtual NW information management table 323 (step S1307).

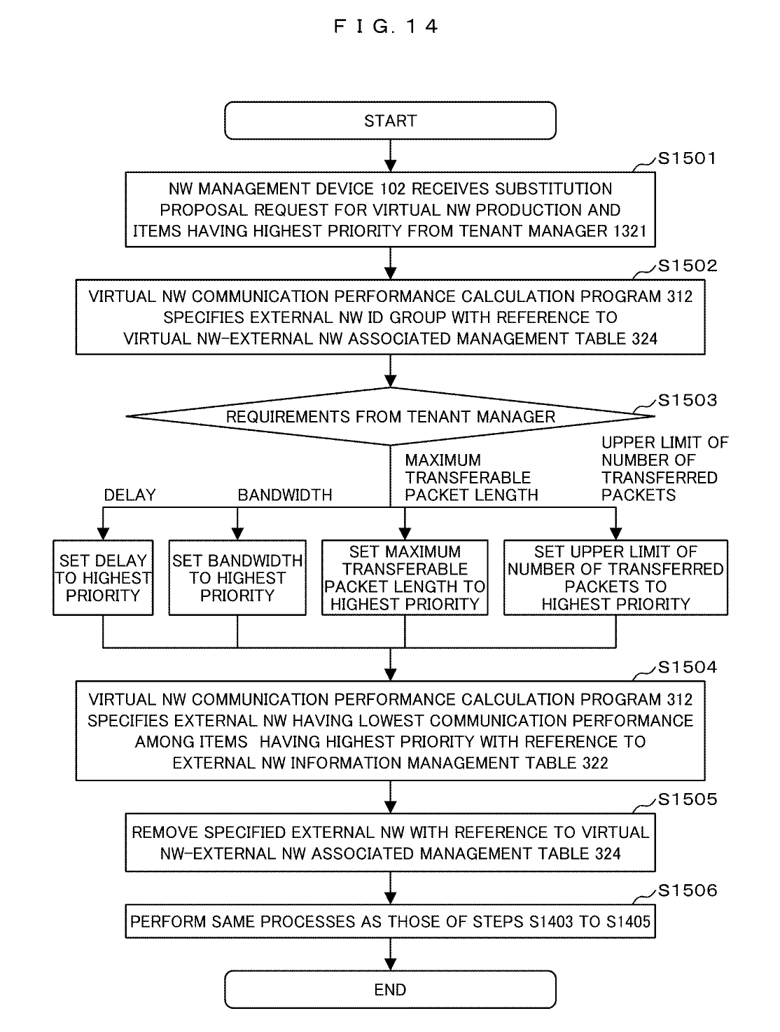

The processes of S1303 to S1307 will be described in detail with reference to FIG. 14.

If the NW management device 102 receives approval representing reception of the notified performance of the virtual NW from the tenant manager 1321 (step S1308), the NW management device 102 sets the virtual NW tag to the gateway 104 (step S1309), and updates the virtual NW tag column of the virtual NW information management table 323 (step S1310). More specifically, for example, the NW management device 102 produces the virtual NW tag 20 with respect to the gateway IDs 1 to 3. Therefore, the virtual NW ID 2 is constructed in the network system 100, and the VM 106 A2, the VM 106 B2, and the VM 106 C2 can communicate with each other on the virtual NW 2.

If the notified communication performance includes items which can be controlled by the host 107, for example, the maximum transfer packet length, even in a case where the notified communication performance does not satisfy the initial requirements, the tenant manager 1321 may instruct matching the controllable items with communication performance and issue approval.

The instruction is issued to the NW management device 102 by the tenant manager 1321. The NW management device 102 performs the control according to the instruction on the host 107 or on the gateway 104.

The case where the tenant manager 1321 requests a substitution proposal for some reasons such as the case where the communication performance of the virtual NW notified by the NW management device 102 is not in accordance with the desire of the tenant manager 1321 will be described.

If the NW management device 102 receives an substitution proposal request from the tenant manager 1321 and items of the performance requirement having the highest priority (step S1311), the NW management device specifies the external NW having the lowest communication performance among the performance requirements designated from the tenant manager with reference to the external NW ID included in the external NW ID column of the virtual NW-external NW associated management table 324 and with reference to the external NW information management table 322 corresponding to the external NW ID group. The NW management device 102 removes the external NW ID from the virtual NW-external NW associated management table 324 (step S1312) and updates the value of the virtual NW information management table 323 (step S1313). The NW management device 102 notifies the update result to the tenant manager 1321 (step S1314).

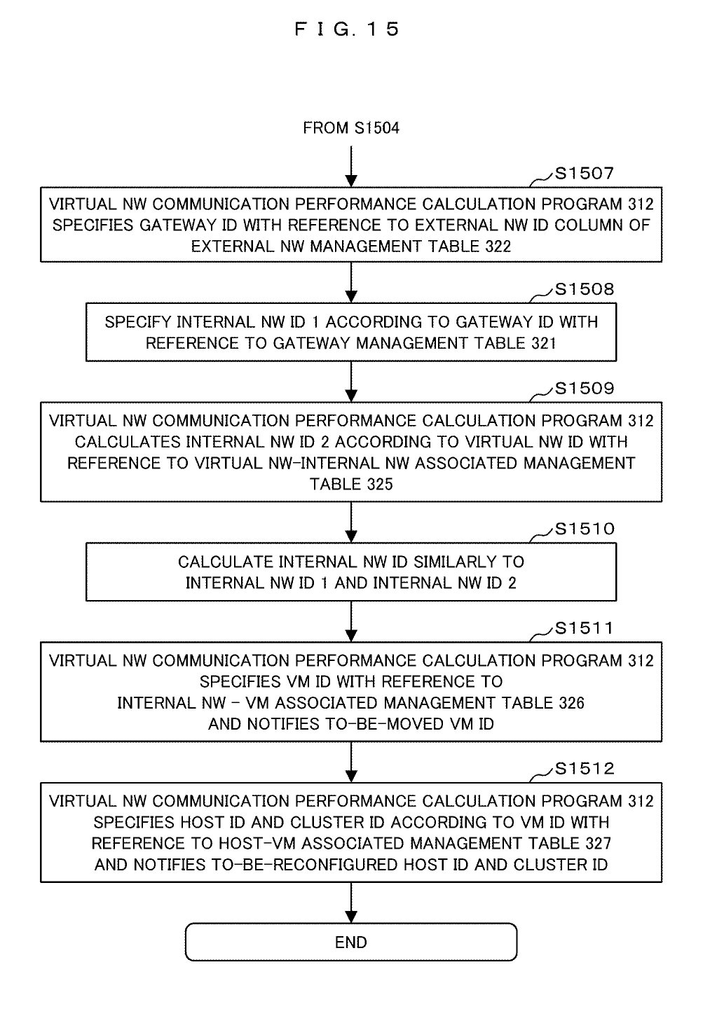

The processes of S1311 to S1314 will be described in detail with reference to FIG. 15.

In the embodiment, although the example where the calculation result is notified to the tenant manager 1321, it may be determined in step S1310 by taking into consideration the calculation result whether or not the NW management device 102 satisfies the performance requirements, and the VM movement or the cluster reconfiguration may be performed directly or through the VM management device or the like managing the VM.

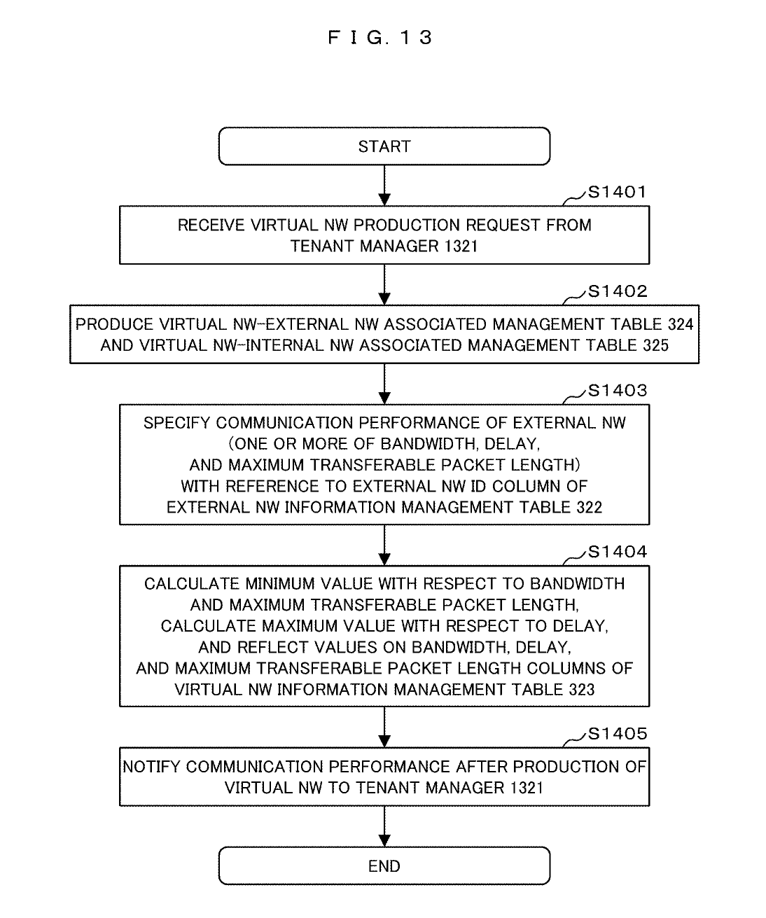

FIG. 13 is a flowchart illustrating an operation example of the virtual NW communication performance calculation program 312 of the NW management device 102. The processes of the flowchart are executed after step S1302 of FIG. 13 is ended and correspond to the processes of steps S1303 to S1307.

If the virtual NW communication performance calculation program 312 receives the calculation request for the communication packet of the virtual NW from the tenant manager 1321 (step S1401), the virtual NW ID and the internal NW ID designated from the request are acquired, and the acquired contents are input to the items of the virtual NW ID 901 and the internal NW ID 902 in the virtual NW-internal NW associated management table 325.

The virtual NW communication performance calculation program 312 specifies the gateway ID corresponding to the internal NW ID from the gateway information management table 321 and specifies the external NW ID from the gateway ID of the external NW information management table 322. The virtual NW ID and the external NW ID of the calculation result are input to the items of the virtual NW-external NW associated management table 324 (step S1402).

Next, the measurement result, for example, a bandwidth, a delay, a maximum transferable packet length, and the like are specified from the external NW ID with reference to the external NW information management table 322 (step S1403). The minimum value of the value of 1-bps or more of bandwidth, the minimum value of the value of 1-byte or more of maximum transferable packet length, and the maximum value of the values of 1-microsecond or more of delay acquired in step S1403 are calculated, the values as the communication performance of the virtual NW are input to the bandwidth, delay, and maximum transfer packet length columns of the virtual NW information management table 323 (step S1404).

The virtual NW communication performance calculation program 312 notifies the calculation result to the tenant manager 1321 (step S1405). Accordingly, information indicating the communication performance after the construction of the virtual NW is provided to the tenant manager 1321.

The NW management device 102 or the tenant manager 1321 manipulating the NW management device can determine with reference to the notified communication performance whether or not to use the virtual NW.

In addition, for example, as the maximum transferable packet length, there are the performance requirements which the VM can control in accordance with the calculated communication performance. In this case, in response to the provided communication performance information, the NW management device 102 may be configured to allow the VM to control the performance requirements. More specifically, the VM may be instructed to change the maximum transferable packet length in accordance with the communication performance.

FIG. 14 is flowchart illustrating an operation example when the NW management device 102 receives a substitution proposal request from the tenant manager 1321. The processes of the flowchart are executed after step S1310 of FIG. 12B is ended and correspond to the processes of steps S1311 to S1314.

If an substitution proposal request including items of the performance requirements having the highest priority is received from the tenant manager 1321 (step S1501), the virtual NW communication performance calculation program 312 specifies the external NW ID group corresponding to the virtual NW ID with reference to the virtual NW ID column of the virtual NW-external NW associated management table 324 (step S1502). The NW management device 102 defines the items of the performance requirement to which the tenant manager 1321 gives the highest priority and which is included in the substitution proposal request (step S1503).

The virtual NW communication performance calculation program 312 specifies the external NW having the lowest communication performance among the values of the items having the highest priority defined in step S1503 from the bandwidth, delay, the maximum transferable packet length of the external NW ID from the external NW information management table 322. Herein, in a case where the item having the highest priority is bandwidth, the external NW having the lowest communication performance is an external NW having 1-bps or more of minimum bandwidth; in a case where the item having the highest priority is delay, the external NW having the lowest communication performance is an external NW having 1-microsecond or more of maximum delay; and in a case where the item having the highest priority is maximum transfer packet length, the external NW having the lowest communication performance is an external NW having 1-byte or more of minimum value (step S1504).

The virtual NW communication performance calculation program 312 removes the ID of the external NW corresponding to the virtual NW ID of the virtual NW-external NW associated management table 324 (step S1505), performs the processes such as steps S1403 to S1405 of FIG. 13, and notifies the communication performance of the virtual NW ID to the tenant manager 1321 (step S1506).

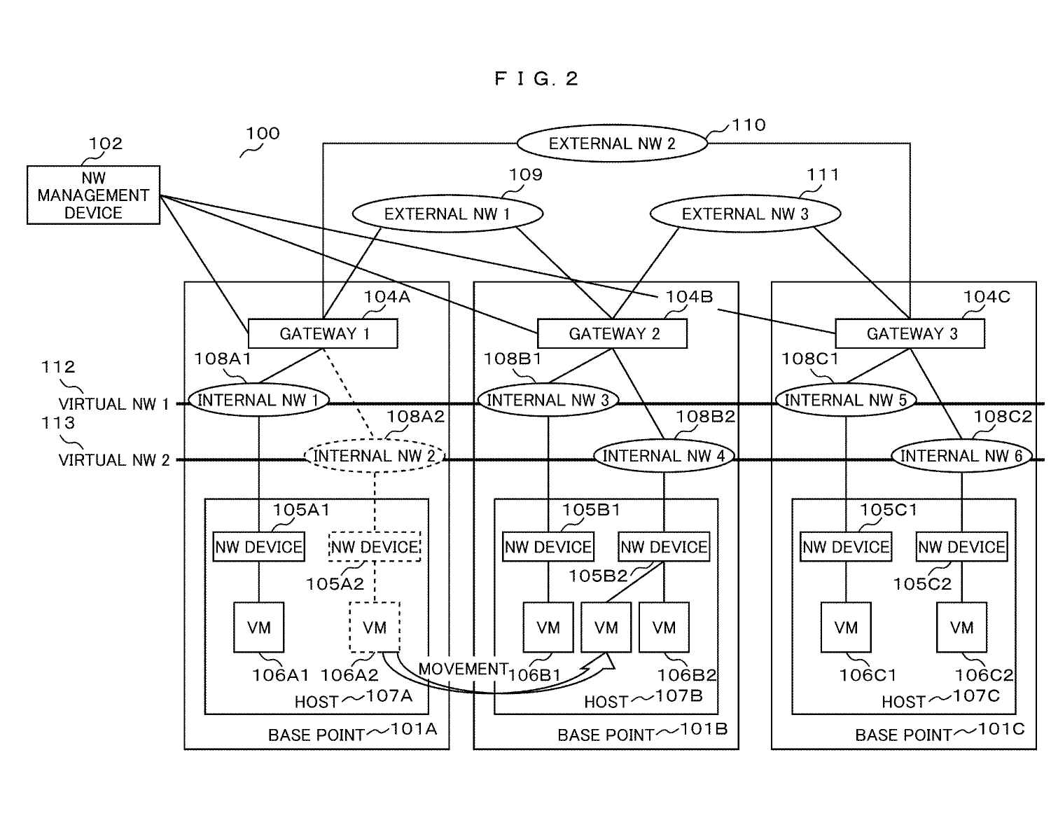

Another example relating to production of the substitution proposal will be described with reference to FIGS. 2 and 15.

FIG. 2 is an explanation diagram illustrating an example of providing a network in the network system 100. In FIG. 2, it is assumed that the external NW 109 is a low-performance physical NW, and the external NWs 110 and 111 are high-performance physical NW. Since the virtual NW 113 includes the low-performance external NW 109, deterioration occurs in the communication performance.

In a case where the performance requirements of the tenant manager are not satisfied, the NW management device 102 can notify to the tenant manager a message indicating that the communication through the low-performance external NW 109 is avoided by moving the VM 106 A2 from the base point 101A to the base point 101B and the communication performance can be improved. As another method, the NW management device 102 may move the VM 106 A2 from the base point 101A to the base point 101B directly or through the VM management device managing the VM 106 and the host 107.

The flowchart illustrated in FIG. 15 is performed after step S1504 of FIG. 14.

The virtual NW communication performance calculation program 312 specifies the gateway ID corresponding to the specified external NW ID from the external NW information management table 322 (step S1507) and specifies the internal NW ID corresponding to the gateway ID from the gateway information management table 321 (step S1508).

The virtual NW communication performance calculation program 312 specifies the internal NW ID corresponding to the virtual NW ID with reference to the virtual NW-internal NW associated management table 325 (step S1509). The internal NW ID which is common to the internal NW ID specified in step S1508 and the internal NW ID specified in step S1509 is calculated (step S1510).

The virtual NW communication performance calculation program 312 specifies the VM ID corresponding to the internal NW ID with reference to the internal NW-VM associated management table 326 and notifies the to-be-moved VM ID to the tenant manager 1321 (step S15011). The virtual NW communication performance calculation program 312 specifies the host ID and the cluster ID corresponding to the VM ID with reference to the host-VM associated management table 327 and notifies the to-be-reconstructed host ID and cluster ID to the tenant manager 1321 (step S1512).

The system configuration is re-designed by the tenant manager 1321, so that the communication performance is improved.

The flowchart illustrates the example where, when the NW management device receives the substitution proposal request from the tenant manager 1321, the NW management device notifies the communication performance of the re-designed virtual NW to the tenant manager 1321. The tenant manager 1321 performs VM movement or server cluster reconstruction by taking into consideration the result, so that the communication performance on the virtual NW can be improved.

While the disclosure is described with respect to representative embodiments, the ordinarily skilled in the art can understand that various changes and modifications are available in the form and details without departing from the spirit and scope of the disclosed subject matter. For example, the configurations described in the above-described embodiments may not be entirely equipped. In addition, a portion of the configurations of some embodiment may be transferred to other embodiments. In addition, the configurations of some embodiment may be added with the configurations of other embodiments. In addition, a portion of the configurations of each embodiment may be added, removed, or replaced with other configurations. In addition, a portion or all of the above-described configurations, functions, processing units, processing means, or the like may be implemented in a hardware manner by designing, for example, as integrated circuits or the like or may be implemented in a software manner by allowing a processor to analyze and execute programs implementing functions.

Information on the programs, tables, files, and the like for implementing the functions may be stored in a storage device such as a memory, a hard disk, an SSD (Solid State Drive) or a recording medium such as an IC card, an SD card, or a DVD.

In addition, only the control lines or information lines which are considered to be necessary for the description are illustrated, but it is not considered that all the control lines or information lines necessary for installation are illustrated. Actually, it may be considered that almost all the configurations are connected to each other.

What is claimed is:

1. A network system having a plurality of computer systems equipped with a computer, comprising:
a management device; and
one or more external networks which connect each of any two of the computer systems;
wherein the management device
acquires communication performance of each of the external networks,
receives a calculation request for the communication performance of a virtual network,
specifies a configuration of the requested virtual network,
calculates the communication performance of the specified virtual network based on the acquired communication performance of the external network, and
provides information of the calculated communication performance of the virtual network to a manager.

2. The network system according to claim 1,
wherein the computer system includes a gateway connecting an internal network and the external network, and
wherein the management device
specifies the gateway connected to each of the external networks,
requests the gateway to transmit the communication performance of the external network, and
acquires the requested communication performance from the gateway.

3. The network system according to claim 1,
wherein any two or more of the computer systems of the network system include a computer used by the same tenant,
wherein a calculation request for the communication performance is associated with the virtual network connecting the computer used by the tenant by a manager of the tenant, and
wherein the management device
specifies the computer used by the tenant,
specifies the external network connected to the computer,
specifies the virtual network which is configured with the specified external network and is used by the tenant, and
provides the information of the virtual network of the tenant calculated based on the acquired communication performance of the external network to the manager of the tenant.

4. The network system according to claim 1, wherein the calculation request includes information of the external network constituting the virtual network.

5. The network system according to claim 1, wherein, if the management device receives an approval of the manager with respect to the provided communication performance, the management device sets a virtual network identifier with respect to the approved virtual network and constructs the virtual network.

6. The network system according to claim 1, wherein, in a case where substitution proposal production is requested with respect to the providing of the communication performance, the management device calculates a re-design proposal for the virtual network.

7. The network system according to claim 6, wherein the request for the substitution proposal production includes designation of an item having a highest priority among a plurality of items of the communication performance.

8. The network system according to claim 6,
wherein the management device
specifies the external network having a lowest communication performance measured according to the item having the highest priority among the external networks,
specifies a configuration of the virtual network which does not use the specified external network, and
calculates the communication performance of the reconstructed virtual network as the re-design proposal.

9. The network system according to claim 6,
wherein an external network of which the measured communication performance associated with an item having a highest priority is lowest is specified among the external networks,
wherein a configuration of a virtual network which does not use the specified external network is specified,
wherein a virtual machine connected to the virtual network is specified, and
wherein the virtual network which does not use the external network is configured by moving the specified virtual machine to another computer system.

10. The network system according to claim 6, wherein, in a case where the provided communication performance includes items which can be controlled by the computer system, the management device controls the computer system to perform communication in accordance with the provided communication performance with respect to any one of the items which can be controlled.

11. The network system according to claim 1, wherein the communication performance includes any one or more of a bandwidth, a delay, and a maximum transfer packet length.

12. The network system according to claim 10, wherein the controllable item includes a maximum transfer packet length.
